(19) United States
(12) Patent Application Publication
(10) Pub. No.: US 2007/0191397 A1
(43) Pub. Date: Aug. 16, 2007

(54) Fungicidal mixtures based on oxime ether derivatives

(76) Inventors: Jordi Tormo i Blasco, Laudenbach (DE); Thomas Grote, Wachenheim (DE); Eberhard Ammermann, Heppenheim (DE); Reinhard Stierl, Freinsheim (DE); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(21) Appl. No.: 11/579,084

(22) PCT Filed: May 17, 2004
(86) PCT No.: PCT/EP04/05281

§ 371 Date: Oct. 30, 2006

(51) Int. Cl. A01N 43/90; A01N 37/18

(52) U.S. Cl. 514/259.31; 514/617

(57) ABSTRACT

The invention relates to fungicidal mixtures containing: A) triazolopyrimidine of formula (I) and B) oxime derivatives of formula (II), wherein the index and substitutents have the following meaning: X=C₁-halogen alkyl or C₁-halogen alkoxy; R=halogen, alkyl, halogen alkyl, alkoxy or halogen alkoxy; n=0, 1, 2 or 3 in a synergistically effective amount. The invention also relates to a method for controlling harmful fungi with mixtures of compounds (I) and (II), to the agents containing said mixtures and to the utilization of compounds (I) and (II) for the production of said mixtures.

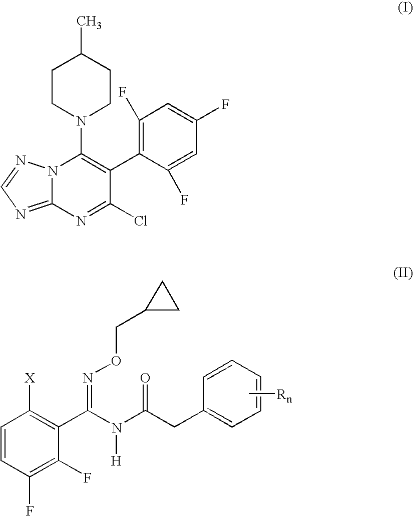

The present invention relates to fungicidal mixtures, comprising
A) the triazolopyrimidine of the formula I 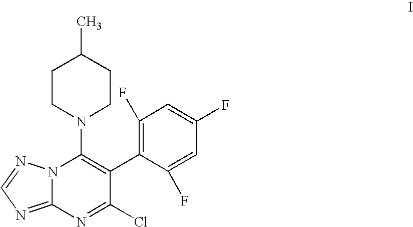
and
   B) oxime ether derivatives of the formula II 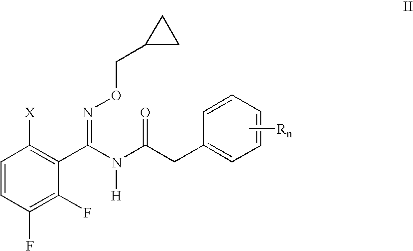
where the index and the substitutents are as defined below:
X is C₁-haloalkyl or C₁-haloalkoxy;
R is halogen, C₁-C₄-alkyl, C₁-C₄-haloalkyl, C₁-C₄-alkoxy or C₁-C₄-haloalkoxy;
n is 0, 1, 2 or 3;
   in a synergistically effective amount.

Moreover, the invention relates to methods for controlling harmful fungi using mixtures of the compounds I and II, to compositions comprising these compounds and to the use of the compounds I and II for preparing such mixtures.

The compound of the formula I, 5-chloro-7-(4-methylpiperidin-1-yl)-6-(2,4,6-trifluoro-phenyl)-[1,2,4]triazolo[1,5-a]pyrimidine, its preparation and its action against harmful fungi are known from the literature (WO 98/46607).

Mixtures of triazolopyrimidines with other active compounds are disclosed in EP-A 988 790 and U.S. Pat. No. 6,268,371.

Also known are the oxime ether derivatives of the formula II and processes for their preparation (WO 96/19442, EP-A 10 17 670 and EP-A 10 17 671).

WO 98/53689, WO 99/31980 and WO 00/36917 disclose mixtures of the oxime ether derivatives of the formula II with other active compounds.

It was an object of the present invention to provide particularly effective mixtures for controlling harmful fungi and in particular for certain indications.

It was an object of the present invention to provide, with a view to reducing the application rates and to broaden the activity spectrum of the known compounds I and II, mixtures which, at a reduced total amount of active compounds applied, have an improved effect against harmful fungi (synergistic mixtures).

We have found that this object is achieved by the mixtures defined at the outset. Moreover, we have found that simultaneous, that is joined or separate, application of the compounds I and the compounds II or successive application of the compounds I and the compounds II allows better control of harmful fungi than is possible with the individual compounds alone.

The mixtures according to the invention act synergistically and are therefore particularly suitable for controlling harmful fungi and in particular powdery mildew fungi in cereals, vegetables, fruit, ornamentals and grapevines.

The mixtures according to the invention preferably comprise the compound of the formula I and a compound of the formula II as active components.

Among the compounds of the formula II, preference is given to those in which X is a trifluoromethyl or a difluoromethoxy group. In addition, particular preference is given to the compounds of the formula II in which the index n is zero.

Particularly preferred compounds II are in particular the compounds listed in Table 1 below:

TABLE 1

| No. | X | Rₙ |
|---|---|---|
| II.1 | CF₃ | H |
| II.2 | CHF₂ | H |
| II.3 | CF₃ | 4-OCH₃ |
| II.4 | CHF₂ | 4-OCH₃ |
| II.5 | CF₃ | 4-F |
| II.6 | CHF₂ | 4-F |
| II.7 | CF₃ | 4-Cl |
| II.8 | CHF₂ | 4-Cl |
| II.9 | CF₃ | 4-CH₃ |
| II.10 | CHF₂ | 4-CH₃ |
| II.11 | CF₃ | 4-CF₃ |
| II.12 | CHF₂ | 4-CF₃ |
| II.13 | OCF₃ | H |
| II.14 | OCHF₂ | H |
| II.15 | OCH₂F | H |
| II.16 | OCF₃ | 4-OCH₃ |
| II.17 | OCHF₂ | 4-OCH₃ |
| II.18 | OCH₂F | 4-OCH₃ |
| II.19 | OCF₃ | 4-F |
| II.20 | OCHF₂ | 4-F |
| II.21 | OCH₂F | 4-F |
| II.22 | OCF₃ | 4-Cl |
| II.23 | OCHF₂ | 4-Cl |
| II.24 | OCH₂F | 4-Cl |
| II.25 | OCF₃ | 4-CH₃ |
| II.26 | OCHF₂ | 4-CH₃ |
| II.27 | OCH₂F | 4-CH₃ |
| II.28 | OCF₃ | 4-CF₃ |
| II.29 | OCHF₂ | 4-CF₃ |
| II.30 | OCH₂F | 4-CF₃ |

The compounds II.1 and in particular II.14 are preferred for use in the mixtures according to the invention.

The ratios of the compounds I and II can be varied within wide ranges; preferably, the active compounds are employed in a weight ratio in the range from 100:1 to 1:50, preferably from 50:1 to 1:2, in particular from 20:1 to 1:1.

When preparing the mixtures, it is preferred to employ the pure active compounds I and II, to which further active compounds against harmful fungi are other pests, such as insects, arachnids, or nematodes, or else herbicidal or growth-regulating active compounds or fertilizers can be added.

The mixtures of the compounds I and II, or the compounds I and II used simultaneously, that is jointly or separately, exhibit outstanding action against a broad spectrum of phytopathogenic fungi, in particular from the classes of the Ascomycetes, Basidiomycetes and Deuteromycetes. Some of them act systemically and can therefore also be employed as folia- and soil-acting fungicides.

They are especially important for controlling a large number of fungi on different crop plants, such as cotton, vegetables (for example cucumbers, beans, tomatoes, potatoes and cucurbits), barley, grass, oats, bananas, coffee, corn, fruit plants, rice, rye, soybeans, grapevine, wheat, ornamentals, sugarcane and a large number of seeds.

They are particularly suitable for controlling the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and grass, Ustilago species on cereals and sugarcane, Venturia inaequalis on apples, Bipolaris and Drechslera species on cereals, rice and grass, Septoria species on wheat, Botrytis cinerea on strawberries, vegetables, ornamentals and grapevines, Mycosphaerella species on bananas, peanuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grapevines, Alternaria species on vegetables and fruit, and also Fusarium and Verticillium species.

The compounds I and II can be applied simultaneously, that is jointly or separately, or in succession, the sequence, in the case of separate application, generally not having any effect on the result of the control measures.

Depending on the nature of desired effect, the application rates of the mixtures according to the invention are, especially on agricultural cultivation areas, from 5 to 2000 g/ha, preferably from 50 to 1500 g/ha, in particular from 50 to 750 g/ha.

Here, the application rates of the compounds I are from 10 to 1000 g/ha, preferably from 20 to 750 g/ha, in particular from 20 to 500 g/ha.

Correspondingly, the application rates of the compounds II are from 5 to 1500 g/ha, preferably from 10 to 750 g/ha, in particular from 20 to 500 g/ha.

In the treatment of seed, the application rates of the mixture are generally from 0.001 to 1 g/kg of seed, preferably from 0.01 to 0.5 g/kg, in particular from 0.01 to 0.1 g/kg.

In the control of phytopathogenic harmful fungi, the separate or joint application of the compounds I and II or of the mixtures of the compounds I and II is carried out by spraying or dusting the seeds, the plants or the soils before or after sowing of the plants or before or after emergence of the plants.

The following are examples of formulations:

1. Products for Dilution with Water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5%). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5%). This mixture is added to water by means of an emulsifier (Ultraturrax) and brought to a homogeneous emulsion. Dilution with water gives an emulsion.

E) Suspensions (SC, OD)

In an agitated ball mill, 20 parts by weight of the active compounds are comminuted with addition of dispersant, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersant, wetters and silica gel. Dilution with water gives a stable dispersion or solution with the active compound.

3. Products to be Applied Undiluted

H) Dustable Powders (DP)

5 parts by weight of the active compounds are ground finely and mixed intimately with 95% of finely divided kaolin. This gives a dustable product.

I) Granules (GR, FG, GG, MG)

5 part by weight of the active compounds is ground finely and associated with 95.5% carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active compounds according to the invention.

Aqueous use forms can be prepared from emulsion concentrates, pastes or wettable powders (wettable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Various types of oils, wetters, adjuvants, herbicides, fungicides, other pesticides, or bactericides may be added to the active compounds, if appropriate just immediately prior to use (tank mix). These agents can be admixed with the agents according to the invention in a weight ratio of 1:10 to 10:1.

### USE EXAMPLES

The synergistic action of the mixtures according to the invention can be demonstrated by the experiments below:

The active compounds, separately or jointly, were prepared as a stock solution with 0.25% by weight of active compound in acetone or DMSO. 1% by weight of the emulsifier Uniperol® EL (wetting agent having emulsifying and dispersing action based on ethoxylated alkylphenols) was added to this solution, and the solution was diluted with water to the desired concentration.

Evaluation was carried out by determining the infected leaf areas in percent. These percentages were converted into efficacies. The efficacy (E) is calculated as follows using Abbot's formula:
E=(1−α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of the mixtures of active compounds are determined using Colby's formula [R.S. Colby, Weeds 15, 20-22 (1967)] and compared with the observed efficacies.
Colby's formula: E=x+y−x·y/100
E expected efficacy, expressed in % of the untreated control, when using the mixture of the active compounds
A and B at the concentrations a and b
x efficacy, expressed in % of the untreated control, when using active compound A at the concentration a
y efficacy, expressed in % of the untreated control, when using active compound B at the concentration b

### Example 1—Curative Action Against Brown Rust of Wheat Caused by Puccinia recondita

Leaves of wheat seedlings of the cultivar “Kanzler”, grown in pots, were dusted with spores of brown rust (Puccinia recondita). The pots were then placed in the chamber with high atmospheric humidity (90-95%), at 20-22° C., for 24 hours. During this time the spores germinated and the germinal tubes penetrated into the leaf tissue. The next day, the infected plants were sprayed to runoff point with an aqueous suspension having the concentration of active compounds stated below. After the spray coating had dried on, the test plants were cultivated in a greenhouse at 20-22° C. and 65-70% relative atmospheric humidity for 7 days. Thereafter, the extent of the rust fungus development on the leaves was determined.

TABLE A
Individual active compounds

| | | | Efficacy |
|---|---|---|---|
| | | | in % of |
| | | Concentration | the |
| Experiment | | in the spray | untreated |
| No. | Active compound | liquor [ppm] | control |
| 1 | Control (untreated) | (90% infect) | 0 |
| 2 | I | 4 | 89 |
| | | 1 | 0 |
| 3 | II.14 | 1 | 0 |
| | | 0.25 | 0 |
| | | 0.06 | 0 |

TABLE B
Combinations according to the invention

| | Mixture of active | | |
|---|---|---|---|
| Experi- | compounds | | |
| ment | Concentration | Observed | Calculated |
| No. | Mixing ratio | efficacy | efficacy*) |
| 4 | I + II.14 | 97 | 89 |
| | 4 + 0.25 ppm | | |
| | 16:1 | | |
| 5 | I + II.14 | 22 | 0 |
| | 1 + 0.06 ppm | | |
| | 16:1 | | |
| 6 | I + II.14 | 99 | 89 |
| | 4 + 1 ppm | | |
| | 4:1 | | |
| 7 | I + II.14 | 33 | 0 |
| | 1 + 0.25 ppm | | |
| | 4:1 | | |
| 8 | I + II.14 | 67 | 0 |
| | 1 + 1 ppm | | |
| | 1:1 | | |

*)Efficacy calculated using Colby's formula

### Example 2—Activity Against Mildew of Wheat Caused by Erysiphe [Syn. Blumeria] graminis Form a Specialis. tritici

Leaves of wheat seedlings of the cultivar “Kanzler” grown in pots, were sprayed to runoff point with an aqueous suspension having the concentration of active compounds stated below. 24 hours after the spray coating had dried on, dusted with spores of mildew of wheat (Erysiphe [syn. Blumeria] graminis form a specialis tritici). The test plants were then placed in a greenhouse at 20-24° C. and 60-90% relative atmospheric humidity. After 7 days, the extent of the mildew development was determined visually in % infection of the entire leaf area.

TABLE C
Individual active compounds

| | | Concentration in | Efficacy in % |
|---|---|---|---|
| | | the | of the |
| Experiment | Active | spray liquor | untreated |
| No. | compound | [ppm] | control |
| 9 | Control | (99% infect) | 0 |
| | (untreated) | | |
| 10 | I | 4 | 60 |
| | | 1 | 9 |
| | | 0.25 | 0 |
| 11 | II.1 | 0.25 | 70 |

TABLE D
Combinations according to the invention

| | Mixture of | | |
|---|---|---|---|
| | active compounds | | |
| Experiment | Concentration | Observed | Calculated |
| No. | Mixing ratio | efficacy | efficacy*) |
| 12 | I + II.1 | 98 | 88 |
| | 4 + 0.25 ppm | | |
| | 16:1 | | |
| 13 | I + II.1 | 95 | 73 |
| | 1 + 0.25 ppm | | |
| | 4:1 | | |
| 14 | I + II.1 | 95 | 70 |
| | 0.25 + 0.25 ppm | | |
| | 1:1 | | |

*)Efficacy calculated using Colby's formula

The test results show that in all mixing ratios the observed efficacy of the mixtures according to the invention is considerably higher than that calculated beforehand using Colby's formula.

1. A fungicidal mixture, comprising
A) the triazolopyrimidine of the formula I 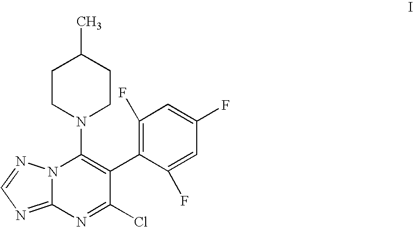
and
B) oxime ether derivatives of the formula II 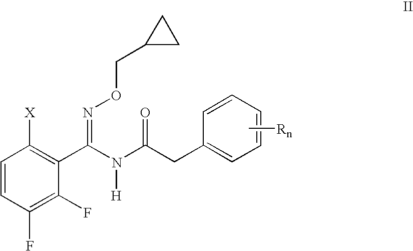
where the index and the substitutents are as defined below:
X is C₁-haloalkyl or C₁-haloalkoxy;
R is halogen, C₁-C₄-alkyl, C₁-C₄-haloalkyl, C₁-C₄-alkoxy or C₁-C₄-haloalkoxy;
n is 0, 1, 2 or 3;
in a synergistically effective amount.

2. The fungicidal mixture according to claim 1, wherein the weight ratio of the compound I to the oxime ether derivatives of the formula II is from 100:1 to 1:50.

3. The fungicidal mixture according to claim 1 or 2, comprising the oxime ether derivative N-[cyclopropylmethoxyimino-(2,3-difluoro-6-trifluoromethylphenyl)methyl]2-phenylacetamide II.1:

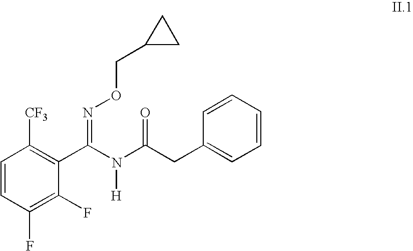

4. The fungicidal mixture according to claim 1 or 2, comprising the oxime ether derivative N-[cyclopropylmethoxyimino-(6-difluoromethoxy-2,3-difluoro-phenyl)methyl]-2-phenylacetamide II.14:

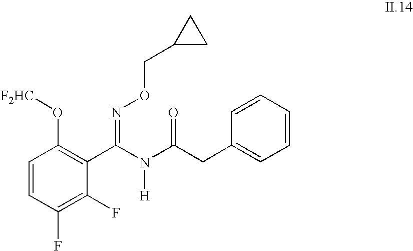

5. A fungicidal composition, comprising the fungicidal mixture according to claim 1 and a solid or liquid carrier.

6. A method for controlling phytopathogenic harmful fungi, which comprises treating the harmful fungi, their habitat or the plants, seeds, soils, areas, materials or spaces to be kept free from them with synergistically effective amounts of the compound of the formula I according to claim 1 and oxime ether derivatives of the formula II.

7. The method according to claim 6, wherein the compound of the formula I and oxime ether derivatives of the formula II are applied simultaneously, that is jointly or separately, or in succession.

8. The method according to claim 6 or 7, wherein the compound of the formula I according to claim 1 is applied in an amount of from 0.01 to 2.5 kg/ha.

9. The method according to claim 6, wherein the oxime ether derivatives of the formula II are applied in an amount of from 0.01 to 1 kg/ha.

10. The method according to claim 6, wherein the compounds I and II are applied in an amount of from 0.001 to 1 g/kg of seed.

11. Seed, comprising the mixture according to claim 1 in an amount of from 0.001 to 1 g/kg.

12. The use of the compounds I and II according to claim 1 for preparing a composition suitable for controlling harmful fungi.
